(19) United States
(12) Patent Application Publication
(10) Pub. No.: US 2025/0245313 A1
(43) Pub. Date: Jul. 31, 2025

(54) MANAGING DEVICE ONBOARDING AFTER COMPONENT REPLACEMENT

(71) Applicant: Dell Products L.P., Round Rock, TX (US)

(72) Inventors: XINGYU WANG, Singapore (SG); RAVINDER TAMISHETTY, Singapore (SG); ERIC JOSEPH BRUNO, Shirley, NY (US)

(21) Appl. No.: 18/426,943

(22) Filed: Jan. 30, 2024

(51) Int. Cl. G06F 21/45

(52) U.S. Cl. CPC G06F 21/45

(57) ABSTRACT

Methods and systems for managing endpoint devices are disclosed. The endpoint devices may be managed by reestablishing authority over them following replacement of components of the endpoint devices. Replacing the components of the endpoint devices may deprive the endpoint devices of use of secrets necessary to validate entities that have authority over them. When such secrets are lost, a replacement process may be performed to establish new secrets and data structures usable by the endpoint devices to establish authority over them.

### FIELD

Embodiments disclosed herein relate generally to device management. More particularly, embodiments disclosed herein relate to systems and methods to manage authority over devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing authority in a distributed system. To manage authority, endpoint devices may be onboarded.

During onboarding, authority over the endpoint devices may be established. The authority may be established using ownership vouchers that include chains of certificates documenting delegations of authority from a root of trust to an owner of the endpoint device.

To use the ownership vouchers, the endpoint devices may rely on secrets retained by hardware components. If the hardware components are replaced, use of the secrets may be lost thereby preventing the endpoint devices from using previously established ownership vouchers.

To re-establish authority over an endpoint device, the endpoint device and management systems may re-establish credentials and ownership vouchers. The credentials and ownership vouchers may be established using previously agreed upon secrets such as secrets for encrypting data and secrets for signing data structures. By doing so, after components of endpoint devices are replaced that deprive the endpoint devices of use of secrets necessary to verify authority delegated by ownership vouchers, authority may be reestablished thereby allowing the endpoint devices to continue to participate in desired computer implemented services.

In an embodiment, a method for managing endpoint devices is provided. The method may include identifying, by a management system tasked with managing a deployment owned by an owner, that a replaced component of an endpoint device of the endpoint devices that will prevent the endpoint device from authenticating the owner as having authority over the endpoint device and which is a member of the deployment; based on the identifying: participating, by the management system, in a channel establishment process to establish a secure channel between the management system and the endpoint device; establishing, by the management system, new credentials for the endpoint device using the secure channel; establishing, by the management system, a new ownership voucher for the endpoint device using the secure channel; providing, by the management system, the new ownership voucher to a voucher management system; obtaining, from the voucher management system and by the management system, an updated new ownership voucher; and onboarding, by the management system and using the updated new ownership voucher, the endpoint device to facilitate authenticating of the owner of the endpoint device.

A component that was replaced by the replacement component may be a trusted platform module that stored a secret usable by the endpoint device to, in part, authenticate the owners of the endpoint device.

The secret may be an onboarding credential.

The onboarding credential may have been usable by the endpoint device to validate an ownership voucher, and the ownership voucher may include a certificate chain delegating authority over the endpoint device to the owner.

The trusted platform module may have stored a second secret that was required for use of a second secure channel between the endpoint device and the management system, and the replacement component may deprive the endpoint device of use of the second secure channel.

The method may also include, prior to the identifying: obtaining, from the voucher management system, a unique manufacturer key.

The new ownership voucher may be established, at least in part, with a signing using the unique manufacturer key.

Establishing the new credential may include storing a new secret in a trusted platform module. The replacement component may be the trusted platform module.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

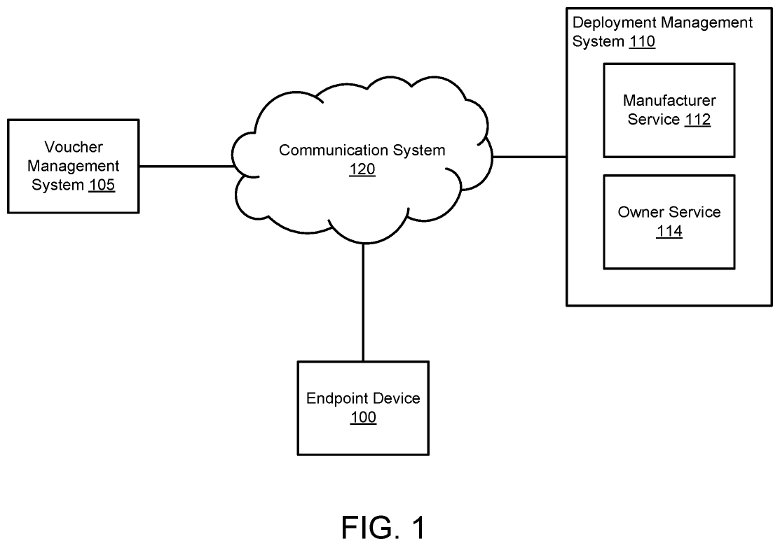

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, any number of endpoint devices may be deployed to a deployment. The endpoint devices may cooperatively provide the computer implemented services.

To manage the endpoint devices to provide the computer implemented services, authority over the endpoint devices may need to be established. In other words, the endpoint devices must be able to ascertain that they are under the authority of a particular entity. Based on this authority, the entity may, for example, issue work order and/or other types of instructions to manage the operation of the endpoint devices to provide desired computer implemented services.

To facilitate ascertaining of the authority over them, the endpoint devices may utilize secrets. The secrets may allow the endpoint devices to cryptographically verify delegations of authority over the endpoint devices from a root of trust (e.g., a trusted key of a manufacturer) to another entity (e.g., an owner).

Overtime components of the endpoint devices may stop functioning. These non-functioning components may prevent the endpoint devices from contributing to the computer implemented services. For example, the non-functioning components may prevent the endpoint devices from using the secrets necessary to cryptographically verify authority over them. Accordingly, the entity tasked with managing them may be deprived of the ability to issue work orders and/or otherwise control the operation of the endpoint devices with such components.

While replacing the non-functioning components may allow the endpoint devices to again be able to utilize secrets, the secrets previously used to cryptographically verify authority over them may be lost. For example, the components may be motherboards (or other type of control boards) that include trusted platform modules that manage secrets used by endpoint devices. Replacement of the motherboard and hosted trusted platform module may cause the secrets usable to cryptographically verify authority over the endpoint devices. Thus, even replacement of the components may not allow for continued use of such secrets thereby depriving the ability of the endpoint devices to contribute to desired computer implemented services.

In general, embodiments disclosed herein may provide methods, systems, and/or devices for managing endpoint devices to improve their likelihood of being able to cryptographically verify authority over them thereby allowing them to contribute to desired computer implemented services. To improve the likelihood, embodiments disclosed herein may provide a framework for replacing secrets and other data structures used in command and control of endpoint devices after component replacement of endpoint devices.

The framework may include processes for establishing secure communication channels, using the secure communication channels to establish new credentials and/or secrets, and using the credentials and/or secrets to establish new ownership vouchers for the endpoint devices after component replacement. The new ownership vouchers may be used, in combination with the new credentials and/or new secrets, to establish authority over the endpoint devices after component replacement. Thus, by establishing authority over the endpoint devices after component replacement, the endpoint devices may be able to contribute to desired component implemented services.

For example, after components replacement, the endpoint devices may utilize the new ownership vouchers, credentials, and secrets to verify delegation of authority of a root of trust an owner or other entity that may use the endpoint devices to provide computer implemented services. Through this delegation of authority, the owner may issue work orders to the endpoint devices that the endpoint devices are able to validate. Accordingly, the endpoint devices may perform the workorders thereby contributing to computer implemented services desired by the owner.

To provide the above noted functionality, the system of FIG. 1 may include endpoint device 100, voucher management system 105, deployment management system 110, and communication system 120. Each of these components is discussed below.

Endpoint device 100 may provide desired computer implemented services to users thereof and/or other devices operably connected to endpoint device 100. To provide the computer implemented services, endpoint device 100 may be onboarded. During onboarding, an endpoint device may operably connect deployment management system 110 and begin following instructions issued by deployment management system 110.

However, prior to doing so, endpoint device 100 may validate authority over it and vested to deployment management system 110. To do so, endpoint device 100 may attempt to validate that a root of trust for endpoint device 100 has delegated authority over it to an owner that operates deployment management system 110. To attempt the validation, endpoint device 100 may utilize a credential and/or key, established at manufacturing time, to verify that a certificate chain can be formed between the root of trust and the owner.

Because the credential and/or the key may be subject to being lost due to component replacement, endpoint device 100 may, when such information is lost due to component replacement, initiate and participate in a process to replace the lost credentials and/or keys. Once replaced, the replacement credentials and/or keys may be used to attempt to validate certificate chains.

Voucher management system 105 may manage ownership vouchers for endpoint devices. An ownership voucher may be created and linked to credentials and/or keys maintained by the endpoint devices. The ownership vouchers may include certificate chains that enable the endpoint devices to validate delegations of authority from the root of trust to an owner.

When an endpoint device is manufactured, an initial voucher may be created and then may be managed by voucher management system 105. However, when endpoint devices lose access to their credentials, voucher management system 105 may facilitate creation of other ownership vouchers (e.g., replacement, etc.). To do so, voucher management system 105 may provide keys and/or other information to deployment management system 110.

Deployment management system 110 may manage endpoint devices that are owned by an owner. To do so, deployment management system 110 may include an owner service (e.g., 114) that obtains and uses ownership vouchers to initially establish ownership and authority over endpoint devices to manage them. For example, owner services 114 may perform various portions of the Fast Identity Online (FIDO) onboarding specification. Likewise, voucher management system 105 may also perform portions of the FIDO onboarding specification such as, for example, the device initialization protocol (DI), the transfer ownership protocol 0 (TO0), and the transfer ownership protocol 2 (TO2). While not shown, the system of FIG. 1 may also include a rendezvous system that may perform the transfer ownership 1 protocol (TO1).

To manage endpoint devices that have suffered components replacement that deprive them of previously established credentials and/or keys, deployment management system 110 may include manufacturer service 112. Manufacturer service 112 may be a service that utilize information provided by voucher management system 105 to establish replacement credentials, keys, and ownership vouchers for component replaced endpoint devices.

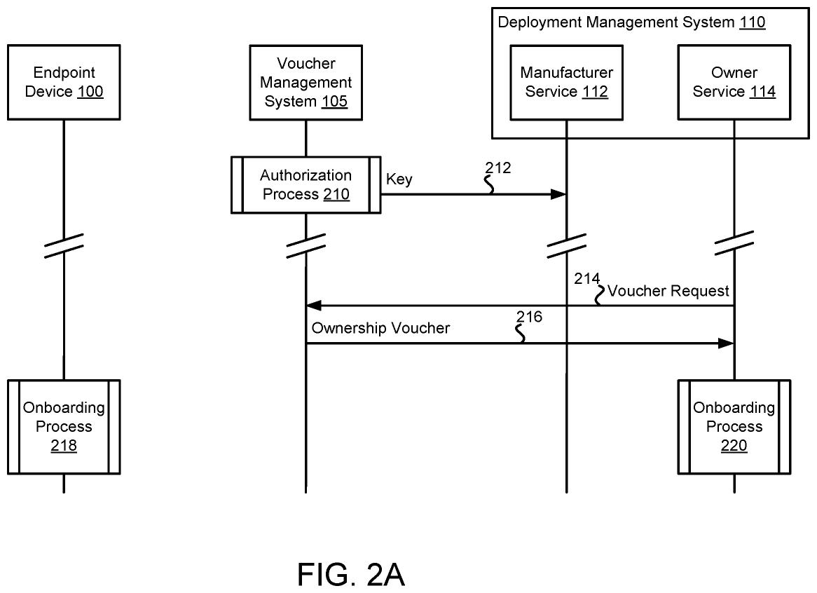

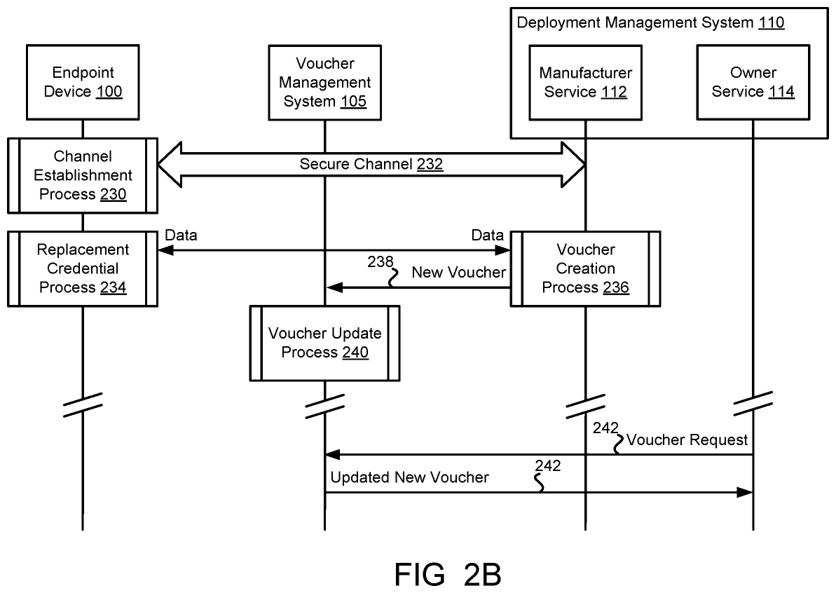

Refer to FIGS. 2A-2B for additional details regarding onboarding of devices and replacement of credentials, keys, and ownership vouchers.

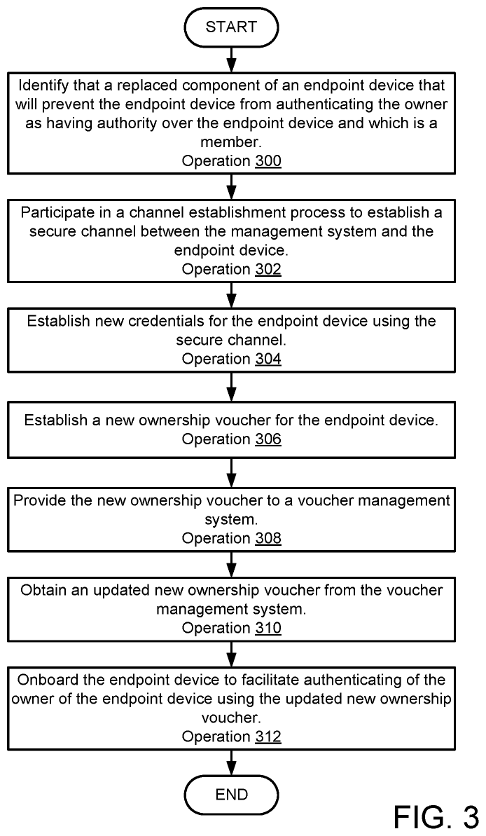

When providing their functionality, any of endpoint device 100, voucher management system 105, and deployment management system 110 may perform all, or a portion, of the processes, interactions, and methods illustrated in FIGS. 2A-3.

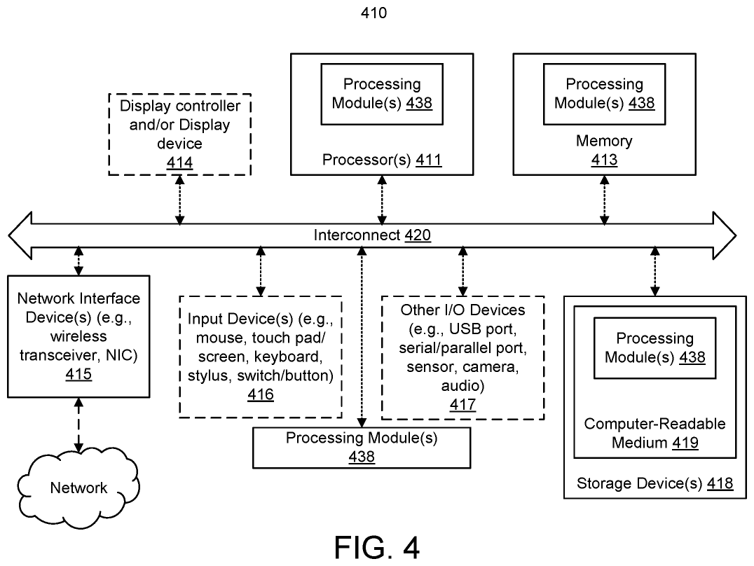

Any of endpoint device 100, voucher management system 105, and deployment management system 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 120. Communication system 120 may facilitate communications between the components of FIG. 1A. In an embodiment, communication system 120 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, interactions diagrams in accordance with an embodiment are shown in FIGS. 2A-2B. These interactions diagrams may illustrate how components of the system of FIG. 1 may interact with one another.

In the interaction diagrams, processes performed by and interactions between components of a system in accordance with an embodiment are shown. In the diagrams, components of the system are illustrated using a first set of shapes (e.g., 100, 105, etc.), located towards the top of each figure. Lines descend from these shapes. Processes performed by the components of the system are illustrated using a second set of shapes (e.g., 210, 220, etc.) superimposed over these lines. Interactions (e.g., communication, data transmissions, etc.) between the components of the system are illustrated using a third set of shapes (e.g., 212, 214, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 212 may occur prior to the interaction labeled as 216. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during onboarding of endpoint device 100 to a system management by deployment management system 110 and owned by an owner.

Prior to the interactions shown in FIG. 2A, endpoint device 100 may be manufactured. When manufactured, the manufacturer may begin preparing endpoint device 100 for eventual onboarding. To do so, endpoint device 100 may be provided with credentials (e.g., device initialization credentials), and/or keys. For example, endpoint device 100 may be provided with information regarding a root of trust (e.g., a public key corresponding to a private keep maintained by the manufacturer). The aforementioned information may be stored in a trusted platform module of endpoint device 100.

Once the credentials are established, an ownership voucher may be created. The ownership voucher may be keyed to the credentials stored in the trusted platform module. Consequently, the ownership voucher may only be used to verify authority over endpoint device 100 while endpoint device 100 has access to the credentials.

Once generated, the manufacturer may transfer the ownership voucher to voucher management system 105.

Once transferred, endpoint device 100 may eventually be purchased by a new owner. The new owner may provide information to the manufacturer regarding its systems (e.g., deployment management system 110), which may in turn be provided to voucher management system 105. The voucher may be updated (e.g., certificates may be added that delegate authority from the root of trust to the new owner).

Once voucher management system 105 obtains the information regarding the new owner, voucher management system 105 may perform authorization process 210. During authorization process, voucher management system may contact manufacturer service 112 hosted by deployment management system 110 and establish a unique manufacturer key for use with endpoint device 100 and deployment management system 110. The key and associations may be registered with voucher management system 105 for future use, and, at interaction 212, a copy of the key may be provided to manufacturer service 112. The key may be, for example, a private key of a public-private key pair.

To prepare to onboard endpoint device 100, owner service 114 may, at interaction 214, send a voucher request to voucher management system 105. In response, voucher management system 105 may, at interaction 216, provide the ownership voucher to owner service 114. The voucher may include a certificate chains and signatures of voucher management system 105 so that owner service 114 is able to verify the authenticity of the ownership voucher. Additionally, the ownership voucher may include credentials, globally unique identifiers, and/or other information usable to onboard endpoint device 100.

Once endpoint device 100 reaches the new owner and is powered on, endpoint device 100 may reach out to a rendezvous system (not shown) which may redirect endpoint device 100 to owner service 114. Owner service 114 and endpoint device 100 may perform corresponding onboarding processes 218, 220 where endpoint device 100 uses the ownership voucher to verify that owner service 114 has been delegated authority over it. Consequently, during onboarding process 220, owner service 114 may issue various work orders to cause endpoint device 100 to perform desired computer implemented services.

Additionally, while not shown, during onboarding processes 218, 220, endpoint device and owner service 114 may exchange information usable to establish a secure connection in the future. For example, the information may include keys usable as symmetric or other types of encryption keys. Rather than storing the aforementioned information in a trusted platform module, endpoint device 100 may store the information in a secure partition in storage for use only in certain situations. For example, the information may be password protected, stored in an embargoed partition, etc.

Thus, at the end of the interactions shown in FIG. 2A, manufacturer service 112 may have access to secrets usable to establish new credentials and ownership vouchers for endpoint device 100, and endpoint device 100 may have access to backup information for establishing a secure connection with deployment management system 110, and components thereof.

Turning to FIG. 2B, a second interaction diagram in accordance with an embodiment is shown. The second interaction diagram may illustrate processes and interactions that may occur to manage loss of access to secrets by an endpoint device.

When a component of endpoint device 100 is replaced after onboarding, some secrets necessary to verify authority over endpoint device 100 may be lost. To manage the loss of access to such secrets, endpoint device may perform various processes. For example, endpoint device 100 may perform certain processes, may boot to a special recovery operating system, and/or may perform other operations to enter into a recovery state.

While in the recovery state, endpoint device 100 may perform channel establishment process 230. During channel establishment process 230, endpoint device 100 may establish secure channel 232 to deployment management system 110. Secure channel 232 may be an encrypted communication channel. Endpoint device 100 may do so using the data previously stored in the partition (e.g., a portion of storage), but not in the trusted platform module that was replaced. For example, a key may be read that may be used to encrypt and decrypt communications sent over secure channel 232, to establish a session key (e.g., a symmetric encryption key known to both ends of the channel) for secure channel 232, etc.

Once established, manufacturer service 112 and endpoint device 100 may cooperatively establish new credentials and ownership vouchers. For example, endpoint device 100 may perform replacement credentials process 234 and manufacturer service 112 may perform voucher creation process 236.

During replacement credential process 234, replacement credentials may be created and stored in the trusted platform module of endpoint device 100, and information regarding the credentials may be provided to manufacturer service 112. Accordingly, during voucher creation process 236, a new ownership voucher may be created based on the replacement credentials and the unique manufacturer key (as discussed with respect to FIG. 2A). For example, the unique manufacturer key may be used to sign certificates delegating authority over endpoint device 100 to the owner of deployment management system 110.

Once created, the new ownership voucher may, at interaction 238, be provided to voucher management system 105. Once obtained, voucher management system 105 may perform voucher update process 240. During voucher update process, voucher management system 105 may validate the new voucher (e.g., verify that it is for endpoint device 100, and is signed using the unique manufacturer key to verify the source of the new ownership voucher). If validated, then voucher management system 105 may also sign the new voucher to obtain an updated new voucher. Once signed, all of the data necessary for endpoint device 100 to onboard back to deployment management system 110 may be in place.

For example, at interaction 242, owner service may send a voucher request to voucher management system 105 to prepare to onboard endpoint device 100. In response, at interaction 242, voucher management system 105 may provide the updated new ownership voucher to owner service 114. Accordingly, once endpoint device 100 contacts owner service 114 (e.g., after being redirected by a rendezvous server), endpoint device 100 may utilize the updated new ownership voucher to validate that deployment management system 110 has been delegated authority over it. In other words, onboarding processes similar to those discussed with respect to FIG. 2A may be performed.

While shown and described with respect to the same owner service, it will be appreciated that endpoint device 100 may be onboarded to other owner services using the updated new ownership voucher without departing from embodiments disclosed herein.

For example, other owner services may request and obtained the updated new ownership voucher, and the rendezvous system may be configured to redirect the endpoint device to other owner services (e.g., may provide different network endpoints).

Thus, via the interactions shown in FIGS. 2A-2B, embodiments disclosed herein may facilitate re-onboarding of endpoint devices after replacement of components that deprive the endpoint devices of previously utilized secrets.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to verify operations to manage the operation of endpoint devices. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for re-onboarding an endpoint device in accordance with an embodiment is shown. The method may be performed by any of the components of the system shown in FIG. 1.

Prior to operation 300, an endpoint device may have been onboarded to become a member of a deployment. However, following onboarding, the endpoint device may have had a component replaced that deprives the endpoint device of credentials and/or other secrets used in validating authority of an owner over it.

At operation 300, a replaced component of the endpoint device that will prevent the endpoint device from authenticating the owner as having authority over the endpoint device is identified. The component replacement may be identified by receiving a message from the endpoint device. The endpoint device may make the identification and send information to other entities regarding the situation. For example, responsive to the identification, endpoint device may initiate performance of recovery processes and during which the endpoint device may contact other systems such as a manufacturer service hosted by a deployment management system. When doing so, the endpoint device may attempt to initiate establishment of a new secure connection between the endpoint device and the deployment management system. A previously established secure connection may be unusable because the replacement component may lack the secrets necessary to use the previously established secure connection (e.g., secrets may be lost due to the replacement)

At operation 302, the deployment management system may participate in a channel establishment process to establish a secure channel between the deployment management system and the endpoint device. The deployment management system may participate, for example, by attempting to verify the endpoint device and if verifiable using shared secrets with the endpoint device to operate the secure connection. The deployment management system may attempt to verify the endpoint device by waiting until an administrator, an automated system, or another entity marks the endpoint device as being in a recovery model. In other words, another entity may need to notify the deployment management system that the endpoint device is in the recover state before the deployment management system will participate in establishing the secure channel. Presuming that the endpoint device can be verified, the deployment management system may cooperate with the endpoint device to establish the secure channel.

At operation 304, new credentials for the endpoint device are established using the secure channel. The new credentials may be established by generating them using any algorithm. Once generated, the new credentials may be sent to the endpoint device or otherwise provided for future use. In an embodiment, the manufacturer service generates the credentials. The endpoint device may store the new credentials in a trusted platform module for future use and retention.

At operation 306, a new ownership voucher for the endpoint device is established. The new ownership voucher for the endpoint device may be established by generating it. The new ownership voucher may be established by including the credentials in the new ownership voucher and using a unique manufacturer key previously provided by a voucher management system to create certificates for the new ownership voucher. The certificates may establish a chain between a root of trust for the endpoint device and the owner (e.g. operator of the deployment management system).

At operation 308, the new ownership voucher is provided to a voucher management system. The new ownership voucher may be provided by sending it via a message, storing it in a particular location, etc. As discussed with respect to FIG. 2B, the voucher management system may attempt to validate the new ownership voucher (e.g., verify that it's for a device that the unique manufacturer key was created, verify that it's signed with the unique manufacturer key, etc.), and sign it if it can be validated.

At operation 310, an updated new ownership voucher is obtained from the voucher management system. The updated new ownership voucher may be sided by the voucher management system. The updated new ownership voucher may be obtained by sending a request for it, and receiving it from the voucher management system.

At operation 312, the endpoint device is onboarded to facilitate authenticating of the owner of the endpoint device using the new updated ownership voucher. For example, the endpoint device may contact an owner service and verify the authority of the owner service over it using the updated ownership voucher (and the new credentials). Consequently, the endpoint device may be managed by the owner service.

The method may end following operation 312.

Thus, using the method shown in FIG. 3, embodiments disclosed herein may facilitate restoration of authority of endpoint devices after components of the endpoint devices are replaced.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing endpoint devices, the method comprising:
identifying, by a management system tasked with managing a deployment owned by an owner, that a replaced component of an endpoint device of the endpoint devices that will prevent the endpoint device from authenticating the owner as having authority over the endpoint device and which is a member of the deployment;
based on the identifying:
participating, by the management system, in a channel establishment process to establish a secure channel between the management system and the endpoint device;
establishing, by the management system, new credentials for the endpoint device using the secure channel;
establishing, by the management system, a new ownership voucher for the endpoint device using the secure channel;
providing, by the management system, the new ownership voucher to a voucher management system;
obtaining, from the voucher management system and by the management system, an updated new ownership voucher; and
onboarding, by the management system and using the updated new ownership voucher, the endpoint device to facilitate authenticating of the owner of the endpoint device.

2. The method of claim 1, wherein a component that was replaced by the replacement component is a trusted platform module that stored a secret usable by the endpoint device to, in part, authenticate the owners of the endpoint device.

3. The method of claim 2, wherein the secret is an onboarding credential.

4. The method of claim 3, wherein the onboarding credential was usable by the endpoint device to validate an ownership voucher, and the ownership voucher comprised a certificate chain delegating authority over the endpoint device to the owner.

5. The method of claim 2, wherein the trusted platform module stored a second secret that was required for use of a second secure channel between the endpoint device and the management system, and the replacement component deprives the endpoint device of use of the second secure channel.

6. The method of claim 1, further comprising:
prior to the identifying:
obtaining, from the voucher management system, a unique manufacturer key.

7. The method of claim 6, wherein the new ownership voucher is established, at least in part, with a signing using the unique manufacturer key.

8. The method of claim 1, wherein establishing the new credential comprises:
storing a new secret in a trusted platform module,
wherein the replacement component is the trusted platform module.

9. A non-transitory machine-readable medium having instructions stored therein, which when executed by a processor, cause the processor to perform operations for managing endpoint devices, the operations comprising:
identifying, by a management system tasked with managing a deployment owned by an owner, that a replacement component of an endpoint device of the endpoint devices that will prevent the endpoint device from authenticating the owner as having authority over the endpoint device and which is a member of the deployment;
based on the identifying:
participating, by the management system, in a channel establishment process to establish a secure channel between the management system and the endpoint device;
establishing, by the management system, new credentials for the endpoint device using the secure channel;
establishing, by the management system, a new ownership voucher for the endpoint device using the secure channel;
providing, by the management system, the new ownership voucher to a voucher management system;
obtaining, from the voucher management system and by the management system, an updated new ownership voucher; and
onboarding, by the management system and using the updated new ownership voucher, the endpoint device to facilitate authenticating of the owner of the endpoint device.

10. The non-transitory machine-readable medium of claim 9, wherein a component that was replaced by the replacement component is a trusted platform module that stored a secret usable by the endpoint device to, in part, authenticate the owners of the endpoint device.

11. The non-transitory machine-readable medium of claim 10, wherein the secret is an onboarding credential.

12. The non-transitory machine-readable medium of claim 11, wherein the onboarding credential was usable by the endpoint device to validate an ownership voucher, and the ownership voucher comprised a certificate chain delegating authority over the endpoint device to the owner.

13. The non-transitory machine-readable medium of claim 10, wherein the trusted platform module stored a second secret that was required for use of a second secure channel between the endpoint device and the management system, and the replacement component deprives the endpoint device of use of the second secure channel.

14. The non-transitory machine-readable medium of claim 9, wherein the operations further comprise:
prior to the identifying:
obtaining, from the voucher management system, a unique manufacturer key.

15. The non-transitory machine-readable medium of claim 14, wherein the new ownership voucher is established, at least in part, with a signing using the unique manufacturer key.

16. The non-transitory machine-readable medium of claim 9, wherein establishing the new credential comprises:
storing a new secret in a trusted platform module,
wherein the replacement component is the trusted platform module.

17. A management system tasked with managing a deployment owned by an owner, comprising:
a processor; and
a memory coupled to the processor to store instructions, which when executed by the processor, cause the management system to perform operations for managing endpoint devices, the operations comprising:
identifying that a replacement component of an endpoint device of the endpoint devices that will prevent the endpoint device from authenticating the owner as having authority over the endpoint device and which is a member of the deployment;
based on the identifying:
participating in a channel establishment process to establish a secure channel between the management system and the endpoint device;
establishing new credentials for the endpoint device using the secure channel;
establishing a new ownership voucher for the endpoint device using the secure channel;
providing the new ownership voucher to a voucher management system;
obtaining, from the voucher management system, an updated new ownership voucher; and
onboarding, using the updated new ownership voucher, the endpoint device to facilitate authenticating of the owner of the endpoint device.

18. The management system of claim 17, wherein a component that was replaced by the replacement component is a trusted platform module that stored a secret usable by the endpoint device to, in part, authenticate the owners of the endpoint device.

19. The management system of claim 18, wherein the secret is an onboarding credential.

20. The management system of claim 19, wherein the onboarding credential was usable by the endpoint device to validate an ownership voucher, and the ownership voucher comprised a certificate chain delegating authority over the endpoint device to the owner.
